(19) United States
(12) Patent Application Publication
(10) Pub. No.: US 2022/0322195 A1
(43) Pub. Date: Oct. 6, 2022

(54) MACHINE LEARNING FOR HANDOVER

(71) Applicant: Telefonaktiebolaget LM Ericsson (publ), Stockholm (SE)

(72) Inventors: Hugo TULLBERG, Nyköping (SE); Johan OTTERSTEN, Stockholm (SE)

(21) Appl. No.: 17/620,344

(22) PCT Filed: Jun. 19, 2019
(86) PCT No.: PCT/IB2019/055181

§ 371 Date: Dec. 17, 2021

(51) Int. Cl. H04W 36/30; H04W 36/32; H04W 36/00

(52) U.S. Cl. CPC H04W 36/305; H04W 36/32; H04W 36/0061

(57) ABSTRACT

According to certain embodiments, a method for use in a network node for predicting handover includes training a first sequential time-based machine learning model using radio link monitoring measurements for a user equipment (UE) from a plurality of geographic positions within a first cluster of cells, times of handover of the UE to target cells of the first cluster of cells, and cell identifiers of the target cells of the first cluster of cells for each handover. The method further includes: predicting a time for a UE handover to a target cell using the first sequential time-based machine learning model, radio link monitoring measurements for the UE, and geographic positions associated with the radio link monitoring measurements; determining whether enough time exists to perform the UE handover before the predicted handover time; and upon determining enough time exists, performing the UE handover to the target cell.

### TECHNICAL FIELD

Embodiments of the present disclosure are directed to wireless communications and, more particularly, to optimizing handover operations using machine learning to predict handover.

### BACKGROUND

To meet the traffic demands in future wireless communication systems, Third Generation Partnership Project (3GPP) fifth generation (5G) radio access network (RAN) architecture includes new frequency bands, for example in the range of 30-100 GHz. The high frequency bands offer wide spectrum for high data rate communications. The coverage range, however, is limited because of system and channel characteristics.

The propagation loss is higher for long range communications at high frequencies. A key method to overcome the range limitations is ultra-dense networks (UDN). A large number of smaller cells will used in future systems, such as 5G new radio (NR). This makes handover operations (users switching between cells) difficult.

A large number of small cells may also introduce interference between the cells. The interference could cause, for example, frequent and unnecessary handovers causing significant network delays. The delays can lead to handover failures. A significant delay can result in a deteriorating signal strength causing the user to lose connection before switching to another cell. These situations are known as handover failures.

Currently, a user equipment (UE) continuously monitors the signal strength from its serving base station. If the signal strength becomes low, the UE needs to provide measurements from neighboring cells, chose the best cell, and request a switch. The signaling required for this type of monitoring as well as continuously performing different kind of measurements is extremely costly in terms of overhead. This can also cause significant network delays. The delays and wasted resources are unacceptable. For small cells, the handover process needs to be smooth and robust.

### SUMMARY

Based on the description above, there currently exist certain challenges with cell handover. For example, handover is extremely important in future networks. Ultra-dense networks may introduce interference between cells. A user equipment (UE) will need to continuously monitor the signal quality from its serving base station, as well as base stations from other cells. This is extremely costly in terms of overhead. Overhead can cause delay which can lead to handover failures. Handover failures can significantly decrease the overall performance of the system.

Certain aspects of the present disclosure and their embodiments may provide solutions to these or other challenges. Particular embodiments include training a machine learning model to perform a handover prediction. The machine learning model learns what cell the user should switch to based on its current signal strength, which eliminates the need to monitor neighboring cells in the form of reference signal received power (RSRP) measurements. This reduces overhead and delay. Refined and reinforcement learning may be used to continuously update the trained machine learning based on new inputs, which provides flexibility if something in the environment changes.

In summary, particular embodiments may include any of the following three components: (a) a method and apparatus to train a learning algorithm using radio signal strength and other information from the current cell; (b) a method and apparatus to predict handover in terms of what cell to switch to and when the handover will occur; and (c) a method and apparatus to maintain learning in real-time to ensure reliability.

According to some embodiments, a method for use in a network node for predicting handover comprises training a first sequential time-based machine learning model using radio link monitoring measurements for a user equipment (UE) from a plurality of geographic positions within a first cluster of cells, times of handover of the UE to target cells of the first cluster of cells. and cell identifiers of the target cells of the first cluster of cells for each handover. The method further comprises: predicting a time for a UE handover to a target cell using the first sequential time-based machine learning model, radio link monitoring measurements for the UE, and geographic positions associated with the radio link monitoring measurements; determining whether enough time exists to perform the UE handover before the predicted handover time; and upon determining enough time exists to perform the UE handover before the predicted handover time, performing the UE handover to the target cell.

In particular embodiments, the method further comprises, upon determining not enough time exists to perform the UE handover before the predicted handover time, updating the first sequential time-based machine learning model based on an estimated time to perform the UE handover. The method may further comprise determining the UE handover to the target cell failed and updating the first sequential time-based machine learning model based on the failure information. The method may further comprise training a second sequential time-based machine learning model using radio link monitoring measurements for a UE from a plurality of geographic positions within a second cluster of cells, times of handover of the UE to target cells of the second cluster of cells, and cell identifiers of the target cells of the second cluster of cells for each handover. Predicting the time for a UE handover to a target cell may further comprise using the second sequential time-based machine learning model, radio link monitoring measurements for the UE, and geographic positions associated with the radio link monitoring measurements.

In particular embodiments, the first sequential time-based machine learning model is a different model than the second sequential time-based machine learning model. Predicting the time for a UE handover to a target cell may use the first or second sequential time-based machine learning model based on a category type of the UE.

In particular embodiments, the method further comprises training a third sequential time-based machine learning model using outputs of the first and second sequential time-based machine learning models. Predicting the time for a UE handover to a target cell comprises using the third sequential time-based machine learning model, radio link monitoring measurements for the UE, and geographic positions associated with the radio link monitoring measurements.

In particular embodiments, the first sequential time-based machine learning model comprises a recurrent neural network or long short-term memory network. Training the first sequential time-based machine learning model may be based on network simulation.

In particular embodiments, the network node is a base station or a core network node.

According to some embodiments, a network node is operable to predict handover. The network node comprises processing circuitry operable to train a first sequential time-based machine learning model using radio link monitoring measurements for a UE from a plurality of geographic positions within a first cluster of cells, times of handover of the UE to target cells of the first cluster of cells; and cell identifiers of the target cells of the first cluster of cells for each handover. The processing circuitry is further operable to: predict a time for a UE handover to a target cell using the first sequential time-based machine learning model, radio link monitoring measurements for the UE, and geographic positions associated with the radio link monitoring measurements; determine whether enough time exists to perform the UE handover before the predicted handover time; and upon determining enough time exists to perform the UE handover before the predicted handover time, perform the UE handover to the target cell.

In particular embodiments, the processing circuitry is further operable to, upon determining not enough time exists to perform the UE handover before the predicted handover time, update the first sequential time-based machine learning model based on an estimated time to perform the UE handover. The processing circuitry may be further operable to determine the UE handover to the target cell failed and update the first sequential time-based machine learning model based on the failure information. The processing circuitry may be further operable to train a second sequential time-based machine learning model using radio link monitoring measurements for a UE from a plurality of geographic positions within a second cluster of cells, times of handover of the UE to target cells of the second cluster of cells, and cell identifiers of the target cells of the second cluster of cells for each handover. The processing circuitry may be operable to predict the time for a UE handover to a target cell by using the second sequential time-based machine learning model, radio link monitoring measurements for the UE, and geographic positions associated with the radio link monitoring measurements.

In particular embodiments, the first sequential time-based machine learning model is a different model than the second sequential time-based machine learning model. The processing circuitry may be operable to predict the time for a UE handover to a target cell by using the first or second sequential time-based machine learning model based on a category type of the UE.

In particular embodiments, the processing circuitry is further operable to train a third sequential time-based machine learning model using outputs of the first and second sequential time-based machine learning models. The processing circuitry is operable to predict the time for a UE handover to a target cell by using the third sequential time-based machine learning model, radio link monitoring measurements for the UE, and geographic positions associated with the radio link monitoring measurements.

In particular embodiments, the first sequential time-based machine learning model comprises a recurrent neural network or long short-term memory network. The processing circuitry may be operable to train the first sequential time-based machine learning model based on network simulation.

In particular embodiments, the network node is a base station or a core network node.

According to some embodiments, a network node is operable to predict handover. The network node comprises a training module and a determining module. The training module is operable to train a first sequential time-based machine learning model using radio link monitoring measurements for a UE from a plurality of geographic positions within a first cluster of cells, times of handover of the UE to target cells of the first cluster of cells, and cell identifiers of the target cells of the first cluster of cells for each handover. The determining module is operable to: predict a time for a UE handover to a target cell using the first sequential time-based machine learning model, radio link monitoring measurements for the UE, and geographic positions associated with the radio link monitoring measurements; determine whether enough time exists to perform the UE handover before the predicted handover time; and upon determining enough time exists to perform the UE handover before the predicted handover time, perform the UE handover to the target cell.

Also disclosed is a computer program product comprising a non-transitory computer readable medium storing computer readable program code, the computer readable program code operable, when executed by processing circuitry to perform any of the methods performed by the network node described above.

Certain embodiments may provide one or more of the following technical advantages. For example, particular embodiments result in reduced complexity, overhead, and delay by predicting handover. Some embodiments result in increased communication performance. Other advantages include flexibility to use different machine learning models.

The prediction model is a supervised learning method in the initial training mode and in the deployed prediction mode performs online updates to the model using reinforcement learning. Particular embodiments use machine learning techniques that have memory and account for sequential information, for example recurrent neural networks/long-short term memory, etc. For online learning, the same technique may be used but updated based on the accuracy of the prediction.

In general, a machine learning method for cell handover reduces overhead, delay and handover failures. This improves the overall performance of the system and aid users close to the cell edge.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 is a block diagram illustrating an example of machine learning training mode;

FIG. 2 is a block diagram illustrating an example of acquired target data for the machine learning model;

FIG. 3 is a block diagram illustrating an example of machine learning online mode;

FIG. 4 is a flow diagram illustrating the machine learning online mode, according to a particular embodiment;

FIG. 5 is a block diagram illustrating overlapping cells and overlapping learning models, according to a particular embodiment;

FIG. 6 is a block diagram illustrating an example stacked machine learning training model;

FIG. 7 is a flow diagram illustrating a stacked machine learning training model, according to a particular embodiment;

FIG. 8 is a block diagram illustrating an example wireless network;

FIG. 9 is a flowchart illustrating an example method in a network node, according to certain embodiments;

FIG. 10 illustrates an example network node, according to certain embodiments; and

FIG. 11 illustrates an example virtualization environment, according to certain embodiments.

### DETAILED DESCRIPTION

Based on the description above, cell handover is important in future networks, such as Third Generation Partnership Project (3GPP) fifth generation (5G) new radio (NR). Ultra-dense networks will introduce interference between cells and a user will need to continuously monitor the signal quality of its own, as well as other cells, which is costly in terms of overhead and can cause delay that can lead to handover failures. Handover failures can significantly decrease the overall performance of the system.

Certain aspects of the present disclosure and their embodiments may provide solutions to these or other challenges. Particular embodiments include training a machine learning model to perform a handover prediction. The machine learning model learns what cell the user should switch to based on its current signal strength, which eliminates the need to monitor neighboring cells in the form of reference signal received power (RSRP) measurements. This reduces overhead and delay. Refined and reinforcement learning may be used to continuously update the trained machine learning based on new inputs, which provides flexibility if something in the environment changes.

Particular embodiments are described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art. Particular embodiments are not limited a particular network node and may be performed, for example, by a base station or a core network node or any suitable combination.

Particular embodiments include two main modes. The training mode trains the prediction model, and the prediction mode is the deployed mode. During deployment some embodiments may switch from the prediction mode to a reinforcement learning type training mode to update and improve the learning model.

During the training mode, the network functions normally according to state of the art. The training mode uses informative features as input to the machine learning model. The features include an indication of which site a user currently occupies as well as the quality of the radio link. The user may continuously monitor the radio link quality.

Another important measure is, for example, the block error rate (BLER). The BLER is a performance measure used for radio link monitoring (RLM) and gives an indication of how well the system is performing. If the RLM measurements decrease below a certain threshold, a user performs reference signal received power (RSRP) measurements from neighboring cells. This introduces both overhead and delay to the system. This delay can be costly in ultra-dense systems and can lead to handover failures if the users fail to switch to another cell before the connection with the current cell is lost. This decreases the overall performance in the system.

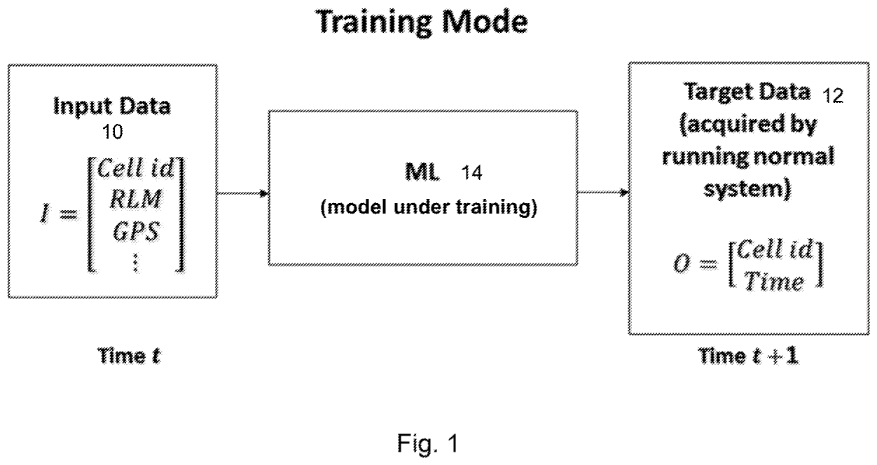

After a user identifies the cell with the best RSRP values, the user can request a switch. This process needs to be quick to establish a new connection in time. Particular embodiments described herein include training a machine learning model for quick handover to reduce delay and overhead. Examples of useful inputs to the machine learning model is the identifier of the current cell, RLM measurements and GPS-coordinates. An example is illustrated in FIG. 1.

FIG. 1 is a block diagram illustrating an example of machine learning training mode. Inputs 10 and outputs 12 are of fixed dimension and remain the same for the prediction (online) mode. Inputs 10 to the untrained machine learning model 14 may include many different features.

In the illustrated example, inputs 10 comprise of the identifier of the cell the user currently occupies, radio link monitoring measurements, GPS-coordinates, etc. Other features that provide useful information about the properties of the radio environment may be used as input to machine learning model 14.

The information is used to predict the identifier of the cell the user should switch to, and when the switch will occur. Outputs (labels) 12 are determined by running the communication system normally.

Machine learning model 14 may be trained by minimizing a loss function. Particular embodiments may use one of many different cost functions. A common cost function is a quadratic cost function, also known as mean squared error, maximum likelihood, and sum squared error.

The dimension of the input and output are fixed for both the training and the prediction (online) mode, i.e., the features used for training also need to be available during the online mode. The output (target) data is used for predicting the identifier of the cell that the user should switch to as well as when to handover will occur.

Particular embodiments are interested in the instance the handover occurs to track whether enough time remains to perform a switch. This is used to avoid handover failures and invoke a different, fall back procedure in case not enough time remains to switch. The time does not depend on the time it takes to perform a prediction, which is relatively quick. It depends on the time it takes to enter the other cell.

By running the system normally according to state of the art, particular embodiments gather the outputs (targets). Particular embodiments predict the time in which a handover occurs as far ahead of time as possible using reported measurement inputs. This is because the user equipment needs time to switch to a new cell.

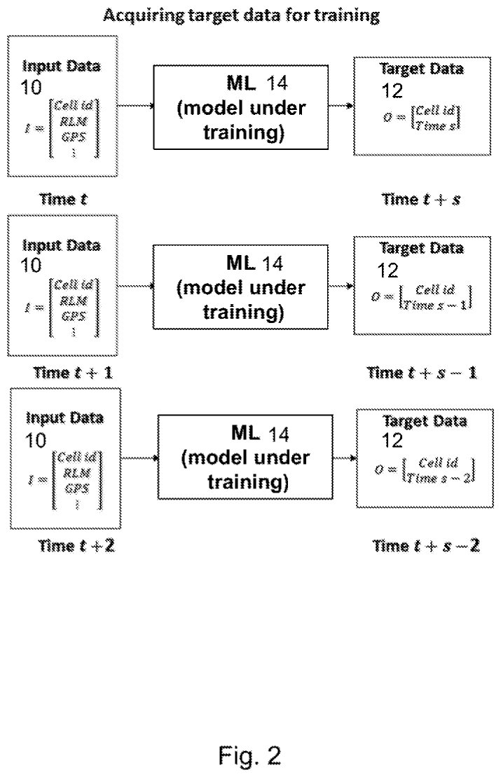

The process of acquiring the output (target) data to the machine learning model to be trained is explained first. An example of acquiring the output (target) data is illustrated in FIG. 2.

FIG. 2 is a block diagram illustrating an example of acquired target data for the machine learning model. At time t, the user equipment (UE) reports input data 10, such as cell identifier, RLM measurements and GPS-coordinates. The system is run normally until a cell handover occurs at time t+s, where s is the time in which a handover occurs. At the time step t+1, machine learning model 14 already has the measurement inputs that were reported, and these are input to machine learning model 14 to predict the time of the same handover, but now at a time t+s−1.

Machine learning model 14 learns that because at time step t+1, the UE is one step closer to the time of handover. The same procedure is done for the next handover and so on.

The training process is a supervised training technique. Particular embodiments repeat the steps until the machine learning model is trained and learns to predict the time of handover and which cell to switch to.

The description above describes how to use the information at time t to predict handover at time t+s. Particular embodiments may also use information from multiple time instants t−k,t−k+1, . . . , t−t, t to predict handover at time t+s. This can improve the performance of the prediction model.

The sequential information provides an indication of the quality of the radio link over time and when handover will occur. Therefore, particular embodiments use a recurrent neural network or long short-term memory networks. In general, embodiments use learning architectures that have a form of memory and account for time. These structures extract the sequential information.

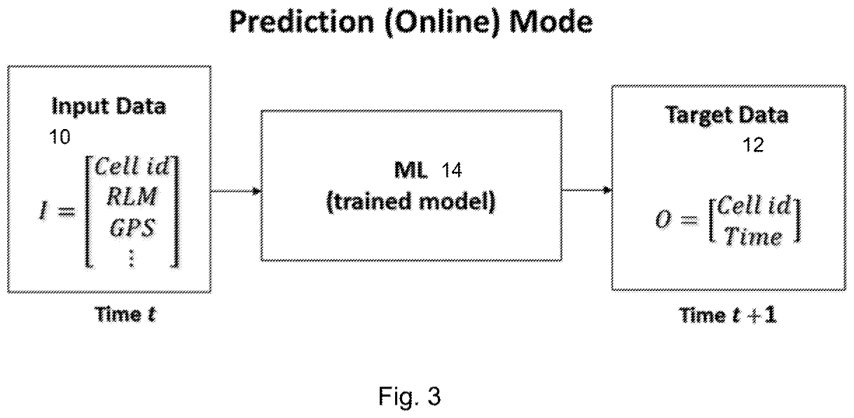

After training mode, particular embodiments transition to the prediction (online) mode. An example is illustrated in FIG. 3.

FIG. 3 is a block diagram illustrating an example of machine learning online mode. In the prediction (online) mode, the dimensions of input 10 and output 12 remain the same as in the training mode. In prediction mode, however, the system no longer runs conventionally. A goal of particular embodiments in prediction mode is to save overhead and delay by predicting handover.

Particular embodiments include a refined learning method used to maintain reliable estimates during prediction (online) mode. By using ACK/NACK information, particular embodiments measure the quality of the predictions. Particular embodiments may use the information to update the trained machine learning model. The model may only be updated when the prediction was incorrect.

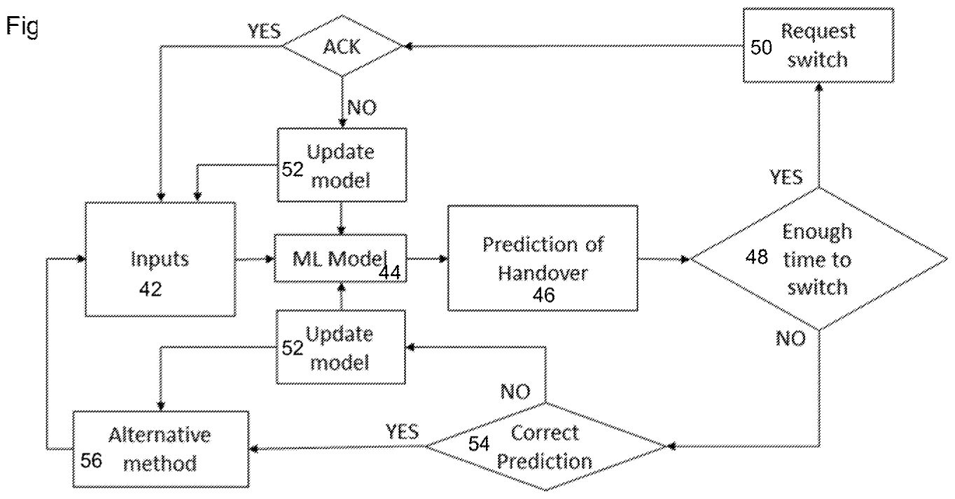

FIG. 4 is a flow diagram illustrating the machine learning online mode, according to a particular embodiment. At step 42, a network node gathers measurements from a UE for use as input to the machine learning model. The input to the machine learning model may include the current cell identifier, RLM measurements, GPS-coordinates, etc. Some embodiments may include other informative features as well.

At step 44, the trained prediction model is updated with the inputs from step 42 and determines an estimate of when a cell handover will occur and the cell identifier of the cell that the UE should switch to at step 46.

At step 46, the network node checks whether enough time is available to switch to another cell. In some embodiments, the network node compares the estimated time (s) in which a handover will occur with an average time to request connection with a cell. If enough time to switch is available, the method continues to step 50 where the network node requests the UE connect to the estimated cell from step 46.

Some embodiments may use the ACK/NACK information to track the success of the handover predictions and so update the prediction model. For example, if the handover is successful, the method returns to step 42 and continues to collect inputs. If the handover is unsuccessful, the method continues to step 52 which triggers an update of the machine learning model before returning to step 42.

Returning to step 48, if not enough time is available to perform the cell handover, the network node may use an alternative method at step 56 to avoid handover failures. Several alternatives exist. One example is to switch to the second-best beam pair link. Beam management requires the UE to perform regular channel state information reference symbol (CSI-RS) measurements to update the best beam pair link. The CSI-RS information can be used to switch to the second-best beam if there is not enough time to switch.

Some embodiments include step 54, where the network node checks whether the estimate of the handover time is correct. The may be used as an indication of the uncertainty of the prediction. If the estimate of the handover time is incorrect, the network node may continue to step 53 to trigger an update of the machine learning model before continuing to step 56. After performing the alternative method at step 56, the method returns to step 42 and may be repeated as often and as many times as necessary.

Although particular examples herein describe predicting when to perform a handover, the machine learning model may also be used to predict when not to perform a handover. For example, if the machine learning model predicts that a decrease in link quality is short lived and signal quality will be restored quickly (e.g., if a user passes by a limited-size blocking at a normal walking speed, it is better to stay in the cell and wait for the signal quality to be restored rather than initiating a handover to a more distant base station).

In some embodiments described herein, the machine learning model may be trained at the cloud. A UE transmits the required information to the cloud.

In some embodiments, the relevant machine learning model may be sent to the UE. This would avoid some of the measurement signaling. The UE acquires the estimates and updates the machine learning model before sending the machine learning model back to the cloud. In both cases, extra signaling is required.

In some embodiments, the machine learning model may be trained at the base station. The embodiments described herein are not limited to a particular node.

Particular embodiments are described in terms of cell handover. Different forms of handover exist, for example from sector to sector within the same cell. The different handovers may require different inputs to the learning model, but the embodiments described herein may apply to all types of handover.

Some embodiments may use different ways to distribute the machine learning models to various sites. Some embodiments may use site specific machine learning models (e.g., one machine learning model per site). The dedicated machine learning model may accurately learn the propagation environment and the prediction of handover of UE to neighboring cells. In particular embodiments, there could be some differences in terms of inputs and outputs to the machine learning model per site.

Some embodiments may group different sites. This can be advantageous for learning handover patterns close to the cell edge.

For example, some embodiments may train one comprehensive machine learning model for all sites. Such an embodiment however, may be costly in terms of training data.

Some embodiments may train different machine learning models dedicated to a group of specific sites instead of having one big machine learning model for all sites, which may improve the performance of the prediction model. It may be easier for the learning methods to learn characteristics of the propagation environment. Location information can, for example, be used to determine which machine learning model to use.

If a site belongs to more than one machine learning model, particular embodiments may check whether both models result in the same prediction, which can determine a level of uncertainty of the predictions. If the predictions of the models agree, there is a higher certainty that they are correct. This indication can aid in generating a reliability system.

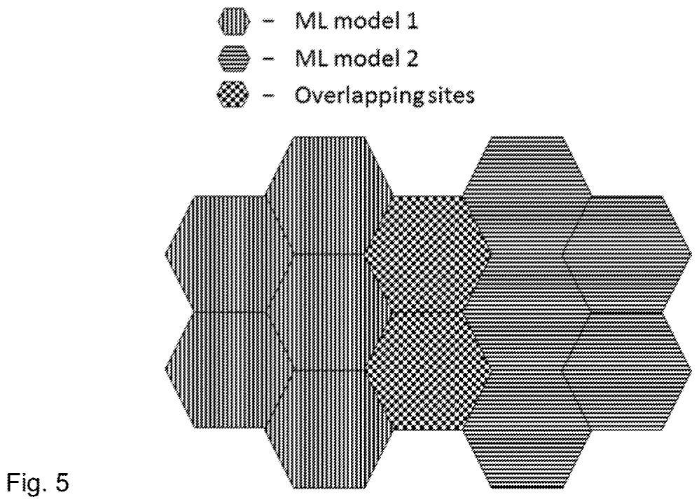

It can be advantageous to group sites so that several sites belong to different machine learning models. Another reliable procedure can be to train stacked machine learning models for the sites that belong to several machine learning models. An example of an architecture and protocol for machine learning model message exchange is illustrated in FIG. 5.

FIG. 5 is a block diagram illustrating overlapping cells and overlapping learning models, according to a particular embodiment. Although the different sites are all illustrated as hexagonal sites, the shapes of the sites are only used as an example.

The illustrated example includes two different machine learning models with seven sites grouped to each one of them. The vertically-lined sites are grouped to ML model 1 and the horizontally-lined sites are grouped to ML model 2. Two of these sites overlap in terms of machine learning model, and they are illustrated with a checkered background.

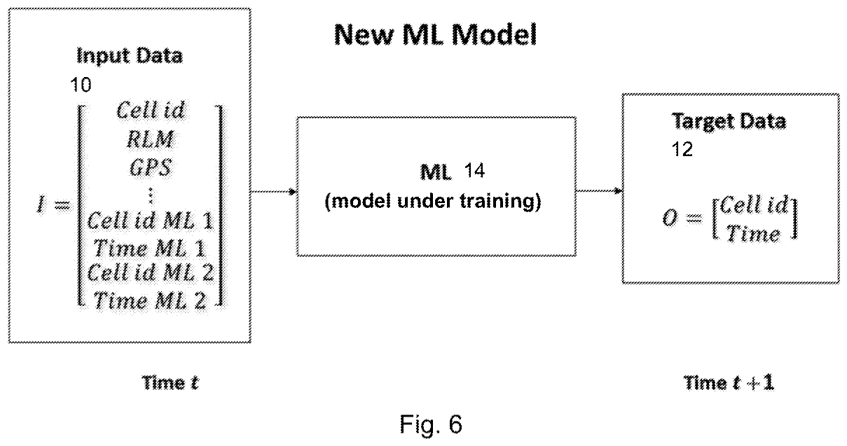

The overlapping sites are trained using both ML 1 and ML 2. When training the overlapping sites, particular embodiments may perform predictions with both of the machine learning models for the training data. The predictions are used as two new features to train a new model. This third model is then used for one of the overlapping sites. There is one new model per overlapping site. This is because the models need to use the same outputs (targets) that were used in the training, which are different for the two overlapping sites. Thus, a new model is used per overlapping site. An example of training of a new machine learning model with the added training features is illustrated in FIG. 6.

FIG. 6 is a block diagram illustrating an example stacked machine learning training model. In the illustrated example, input 10 includes predictions from previously trained machine learning models ML 1 and ML 2. The new machine learning model 14 is trained using the inputs, which results in outputs 12.

As described above, there is one new machine learning model for each overlapping site. Particular embodiments may use a different machine learning training method to combine benefits of different training techniques. Thus, stacking machine learning models for overlapping sites boosts performance.

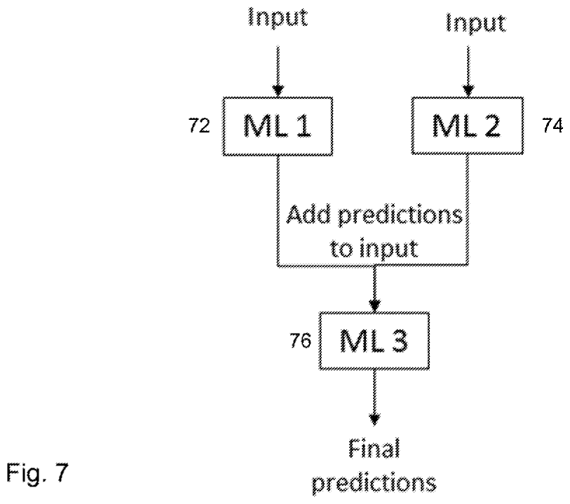

During deployment, particular embodiments may evaluate (send our inputs to) ML 1 and ML 2 before getting the final prediction from ML 3. This may include extra signaling, but in terms of execution time of the prediction models, it would still be relatively fast. In this manner, particular embodiments combine machine learning models, which is advantageous for UE at the cell edge. The prediction accounts for several models, boosting performance. An example of the evaluation of ML 3 during deployment is illustrated in FIG. 7.

FIG. 7 is a flow diagram illustrating a stacked machine learning training model, according to a particular embodiment. At steps 72 and 74, the network node receives input to ML 1 and ML 2, respectively, and evaluates the inputs to determines the predicted handover attributes. The predicted handover attributes are used input to ML 3 at step 76, which evaluates the input values and determines the final predicted handover attributes.

As describes above, particular embodiments may perform machine learning using cloud computing. One advantage of a cloud implementation is that data can be shared between different machine learning models (models for different links). This may facilitate a faster training mode by establishing a common model based on all available input. During the prediction mode, separate models may be used for each group of sites. The model corresponding to a particular group of sites can be updated based on data (ACK/NACK) from that group of sites. This results in models optimized to the specific characteristic of that group of sites.

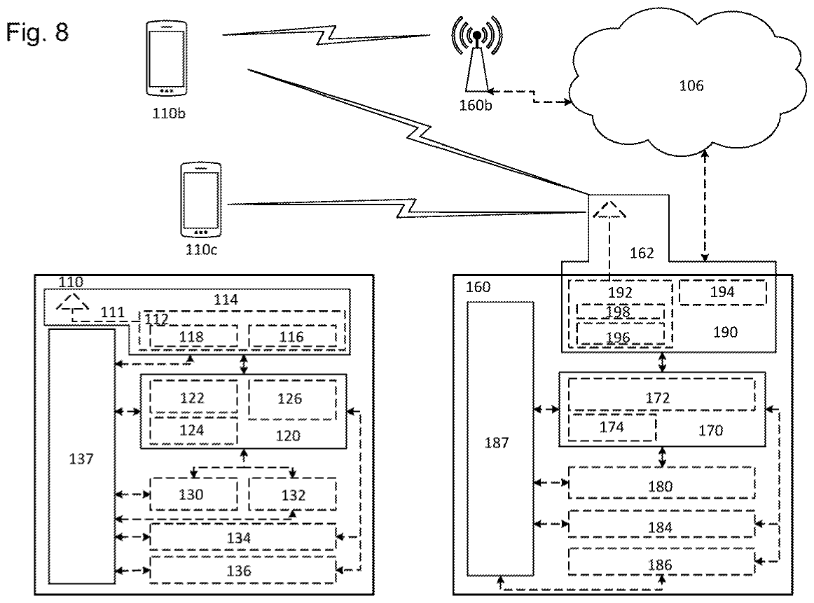

FIG. 8 illustrates an example wireless network, according to certain embodiments. The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 160 and WD 110 comprise various components described in more detail below. These components work together to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 8, network node 160 includes processing circuitry 170, device readable medium 180, interface 190, auxiliary equipment 184, power source 186, power circuitry 187, and antenna 162. Although network node 160 illustrated in the example wireless network of FIG. 8 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein, such as those described with respect to FIGS. 1-7. Moreover, while the components of network node 160 are depicted as single boxes located within a larger box, or nested within multiple boxes, in practice, a network node may comprise multiple different physical components that make up a single illustrated component (e.g., device readable medium 180 may comprise multiple separate hard drives as well as multiple RAM modules).

Similarly, network node 160 may be composed of multiple physically separate components (e.g., a NodeB component and an RNC component, or a BTS component and a BSC component, etc.), which may each have their own respective components. In certain scenarios in which network node 160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 160 may be configured to support multiple radio access technologies (RATs). In such embodiments, some components may be duplicated (e.g., separate device readable medium 180 for the different RATs) and some components may be reused (e.g., the same antenna 162 may be shared by the RATs). Network node 160 may also include multiple sets of the various illustrated components for different wireless technologies integrated into network node 160, such as, for example, GSM, WCDMA, LTE, NR, WiFi, or Bluetooth wireless technologies. These wireless technologies may be integrated into the same or different chip or set of chips and other components within network node 160.

Processing circuitry 170 is configured to perform any determining, calculating, or similar operations (e.g., certain obtaining operations) described herein as being provided by a network node. The operations performed by processing circuitry 170 may include processing information obtained by processing circuitry 170 by, for example, converting the obtained information into other information, comparing the obtained information or converted information to information stored in the network node, and/or performing one or more operations based on the obtained information or converted information, and as a result of said processing making a determination.

Processing circuitry 170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 160 components, such as device readable medium 180, network node 160 functionality. For example, processing circuitry 170 may execute instructions stored in device readable medium 180 or in memory within processing circuitry 170. Such functionality may include providing any of the various wireless features, functions, or benefits discussed herein. In some embodiments, processing circuitry 170 may include a system on a chip (SOC).

In some embodiments, processing circuitry 170 may include one or more of radio frequency (RF) transceiver circuitry 172 and baseband processing circuitry 174. In some embodiments, radio frequency (RF) transceiver circuitry 172 and baseband processing circuitry 174 may be on separate chips (or sets of chips), boards, or units, such as radio units and digital units. In alternative embodiments, part or all of RF transceiver circuitry 172 and baseband processing circuitry 174 may be on the same chip or set of chips, boards, or units

In certain embodiments, some or all of the functionality described herein as being provided by a network node, base station, eNB or other such network device may be performed by processing circuitry 170 executing instructions stored on device readable medium 180 or memory within processing circuitry 170. In alternative embodiments, some or all of the functionality may be provided by processing circuitry 170 without executing instructions stored on a separate or discrete device readable medium, such as in a hard-wired manner. In any of those embodiments, whether executing instructions stored on a device readable storage medium or not, processing circuitry 170 can be configured to perform the described functionality. The benefits provided by such functionality are not limited to processing circuitry 170 alone or to other components of network node 160, but are enjoyed by network node 160 as a whole, and/or by end users and the wireless network generally.

Device readable medium 180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 170. Device readable medium 180 may store any suitable instructions, data or information, including a computer program, software, an application including one or more of logic, rules, code, tables, etc. and/or other instructions capable of being executed by processing circuitry 170 and, utilized by network node 160. Device readable medium 180 may be used to store any calculations made by processing circuitry 170 and/or any data received via interface 190. In some embodiments, processing circuitry 170 and device readable medium 180 may be considered to be integrated.

Interface 190 is used in the wired or wireless communication of signaling and/or data between network node 160, network 106, and/or WDs 110. As illustrated, interface 190 comprises port(s)/terminal(s) 194 to send and receive data, for example to and from network 106 over a wired connection. Interface 190 also includes radio front end circuitry 192 that may be coupled to, or in certain embodiments a part of, antenna 162. Radio front end circuitry 192 comprises filters 198 and amplifiers 196. Radio front end circuitry 192 may be connected to antenna 162 and processing circuitry 170. Radio front end circuitry may be configured to condition signals communicated between antenna 162 and processing circuitry 170. Radio front end circuitry 192 may receive digital data that is to be sent out to other network nodes or WDs via a wireless connection. Radio front end circuitry 192 may convert the digital data into a radio signal having the appropriate channel and bandwidth parameters using a combination of filters 198 and/or amplifiers 196. The radio signal may then be transmitted via antenna 162. Similarly, when receiving data, antenna 162 may collect radio signals which are then converted into digital data by radio front end circuitry 192. The digital data may be passed to processing circuitry 170. In other embodiments, the interface may comprise different components and/or different combinations of components.

In certain alternative embodiments, network node 160 may not include separate radio front end circuitry 192, instead, processing circuitry 170 may comprise radio front end circuitry and may be connected to antenna 162 without separate radio front end circuitry 192. Similarly, in some embodiments, all or some of RF transceiver circuitry 172 may be considered a part of interface 190. In still other embodiments, interface 190 may include one or more ports or terminals 194, radio front end circuitry 192, and RF transceiver circuitry 172, as part of a radio unit (not shown), and interface 190 may communicate with baseband processing circuitry 174, which is part of a digital unit (not shown).

Antenna 162 may include one or more antennas, or antenna arrays, configured to send and/or receive wireless signals. Antenna 162 may be coupled to radio front end circuitry 190 and may be any type of antenna capable of transmitting and receiving data and/or signals wirelessly. In some embodiments, antenna 162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 162 may be separate from network node 160 and may be connectable to network node 160 through an interface or port.

Antenna 162, interface 190, and/or processing circuitry 170 may be configured to perform any receiving operations and/or certain obtaining operations described herein as being performed by a network node. Any information, data and/or signals may be received from a wireless device, another network node and/or any other network equipment. Similarly, antenna 162, interface 190, and/or processing circuitry 170 may be configured to perform any transmitting operations described herein as being performed by a network node. Any information, data and/or signals may be transmitted to a wireless device, another network node and/or any other network equipment.

Power circuitry 187 may comprise, or be coupled to, power management circuitry and is configured to supply the components of network node 160 with power for performing the functionality described herein. Power circuitry 187 may receive power from power source 186. Power source 186 and/or power circuitry 187 may be configured to provide power to the various components of network node 160 in a form suitable for the respective components (e.g., at a voltage and current level needed for each respective component). Power source 186 may either be included in, or external to, power circuitry 187 and/or network node 160. For example, network node 160 may be connectable to an external power source (e.g., an electricity outlet) via an input circuitry or interface such as an electrical cable, whereby the external power source supplies power to power circuitry 187. As a further example, power source 186 may comprise a source of power in the form of a battery or battery pack which is connected to, or integrated in, power circuitry 187. The battery may provide backup power should the external power source fail. Other types of power sources, such as photovoltaic devices, may also be used.

Alternative embodiments of network node 160 may include additional components beyond those shown in FIG. 8 that may be responsible for providing certain aspects of the network node's functionality, including any of the functionality described herein and/or any functionality necessary to support the subject matter described herein. For example, network node 160 may include user interface equipment to allow input of information into network node 160 and to allow output of information from network node 160. This may allow a user to perform diagnostic, maintenance, repair, and other administrative functions for network node 160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air.

In some embodiments, a WD may be configured to transmit and/or receive information without direct human interaction. For instance, a WD may be designed to transmit information to a network on a predetermined schedule, when triggered by an internal or external event, or in response to requests from the network.

Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements and transmits the results of such monitoring and/or measurements to another WD and/or a network node. The WD may in this case be a machine-to-machine (M2M) device, which may in a 3GPP context be referred to as an MTC device. As one example, the WD may be a UE implementing the 3GPP narrow band internet of things (NB-IoT) standard. Examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 110 includes antenna 111, interface 114, processing circuitry 120, device readable medium 130, user interface equipment 132, auxiliary equipment 134, power source 136 and power circuitry 137. WD 110 may include multiple sets of one or more of the illustrated components for different wireless technologies supported by WD 110, such as, for example, GSM, WCDMA, LTE, NR, WiFi, WiMAX, or Bluetooth wireless technologies, just to mention a few. These wireless technologies may be integrated into the same or different chips or set of chips as other components within WD 110.

Antenna 111 may include one or more antennas or antenna arrays, configured to send and/or receive wireless signals, and is connected to interface 114. In certain alternative embodiments, antenna 111 may be separate from WD 110 and be connectable to WD 110 through an interface or port. Antenna 111, interface 114, and/or processing circuitry 120 may be configured to perform any receiving or transmitting operations described herein as being performed by a WD. Any information, data and/or signals may be received from a network node and/or another WD. In some embodiments, radio front end circuitry and/or antenna 111 may be considered an interface.

As illustrated, interface 114 comprises radio front end circuitry 112 and antenna 111. Radio front end circuitry 112 comprise one or more filters 118 and amplifiers 116. Radio front end circuitry 114 is connected to antenna 111 and processing circuitry 120 and is configured to condition signals communicated between antenna 111 and processing circuitry 120. Radio front end circuitry 112 may be coupled to or a part of antenna 111. In some embodiments, WD 110 may not include separate radio front end circuitry 112; rather, processing circuitry 120 may comprise radio front end circuitry and may be connected to antenna 111. Similarly, in some embodiments, some or all of RF transceiver circuitry 122 may be considered a part of interface 114. Radio front end circuitry 112 may receive digital data that is to be sent out to other network nodes or WDs via a wireless connection. Radio front end circuitry 112 may convert the digital data into a radio signal having the appropriate channel and bandwidth parameters using a combination of filters 118 and/or amplifiers 116. The radio signal may then be transmitted via antenna 111. Similarly, when receiving data, antenna 111 may collect radio signals which are then converted into digital data by radio front end circuitry 112. The digital data may be passed to processing circuitry 120. In other embodiments, the interface may comprise different components and/or different combinations of components.

Processing circuitry 120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 110 components, such as device readable medium 130, WD 110 functionality. Such functionality may include providing any of the various wireless features or benefits discussed herein. For example, processing circuitry 120 may execute instructions stored in device readable medium 130 or in memory within processing circuitry 120 to provide the functionality disclosed herein.

As illustrated, processing circuitry 120 includes one or more of RF transceiver circuitry 122, baseband processing circuitry 124, and application processing circuitry 126. In other embodiments, the processing circuitry may comprise different components and/or different combinations of components. In certain embodiments processing circuitry 120 of WD 110 may comprise a SOC. In some embodiments, RF transceiver circuitry 122, baseband processing circuitry 124, and application processing circuitry 126 may be on separate chips or sets of chips. In alternative embodiments, part or all of baseband processing circuitry 124 and application processing circuitry 126 may be combined into one chip or set of chips, and RF transceiver circuitry 122 may be on a separate chip or set of chips. In still alternative embodiments, part or all of RF transceiver circuitry 122 and baseband processing circuitry 124 may be on the same chip or set of chips, and application processing circuitry 126 may be on a separate chip or set of chips. In yet other alternative embodiments, part or all of RF transceiver circuitry 122, baseband processing circuitry 124, and application processing circuitry 126 may be combined in the same chip or set of chips. In some embodiments, RF transceiver circuitry 122 may be a part of interface 114. RF transceiver circuitry 122 may condition RF signals for processing circuitry 120.

In certain embodiments, some or all of the functionality described herein as being performed by a WD may be provided by processing circuitry 120 executing instructions stored on device readable medium 130, which in certain embodiments may be a computer-readable storage medium. In alternative embodiments, some or all of the functionality may be provided by processing circuitry 120 without executing instructions stored on a separate or discrete device readable storage medium, such as in a hard-wired manner. In any of those embodiments, whether executing instructions stored on a device readable storage medium or not, processing circuitry 120 can be configured to perform the described functionality. The benefits provided by such functionality are not limited to processing circuitry 120 alone or to other components of WD 110, but are enjoyed by WD 110, and/or by end users and the wireless network generally.

Processing circuitry 120 may be configured to perform any determining, calculating, or similar operations (e.g., certain obtaining operations) described herein as being performed by a WD. These operations, as performed by processing circuitry 120, may include processing information obtained by processing circuitry 120 by, for example, converting the obtained information into other information, comparing the obtained information or converted information to information stored by WD 110, and/or performing one or more operations based on the obtained information or converted information, and as a result of said processing making a determination.

Device readable medium 130 may be operable to store a computer program, software, an application including one or more of logic, rules, code, tables, etc. and/or other instructions capable of being executed by processing circuitry 120. Device readable medium 130 may include computer memory (e.g. RAM or ROM), mass storage media (e.g., a hard disk), removable storage media (e.g., a CD or a DVD), and/or any other volatile or non-volatile, non-transitory device readable and/or computer executable memory devices that store information, data, and/or instructions that may be used by processing circuitry 120. In some embodiments, processing circuitry 120 and device readable medium 130 may be integrated.

User interface equipment 132 may provide components that allow for a human user to interact with WD 110. Such interaction may be of many forms, such as visual, audial, tactile, etc. User interface equipment 132 may be operable to produce output to the user and to allow the user to provide input to WD 110. The type of interaction may vary depending on the type of user interface equipment 132 installed in WD 110. For example, if WD 110 is a smart phone, the interaction may be via a touch screen; if WD 110 is a smart meter, the interaction may be through a screen that provides usage (e.g., the number of gallons used) or a speaker that provides an audible alert (e.g., if smoke is detected). User interface equipment 132 may include input interfaces, devices and circuits, and output interfaces, devices and circuits. User interface equipment 132 is configured to allow input of information into WD 110 and is connected to processing circuitry 120 to allow processing circuitry 120 to process the input information. User interface equipment 132 may include, for example, a microphone, a proximity or other sensor, keys/buttons, a touch display, one or more cameras, a USB port, or other input circuitry. User interface equipment 132 is also configured to allow output of information from WD 110, and to allow processing circuitry 120 to output information from WD 110. User interface equipment 132 may include, for example, a speaker, a display, vibrating circuitry, a USB port, a headphone interface, or other output circuitry. Using one or more input and output interfaces, devices, and circuits, of user interface equipment 132, WD 110 may communicate with end users and/or the wireless network and allow them to benefit from the functionality described herein.

Auxiliary equipment 134 is operable to provide more specific functionality which may not be generally performed by WDs. This may comprise specialized sensors for doing measurements for various purposes, interfaces for additional types of communication such as wired communications etc. The inclusion and type of components of auxiliary equipment 134 may vary depending on the embodiment and/or scenario.

Power source 136 may, in some embodiments, be in the form of a battery or battery pack. Other types of power sources, such as an external power source (e.g., an electricity outlet), photovoltaic devices or power cells, may also be used. WD 110 may further comprise power circuitry 137 for delivering power from power source 136 to the various parts of WD 110 which need power from power source 136 to carry out any functionality described or indicated herein. Power circuitry 137 may in certain embodiments comprise power management circuitry. Power circuitry 137 may additionally or alternatively be operable to receive power from an external power source; in which case WD 110 may be connectable to the external power source (such as an electricity outlet) via input circuitry or an interface such as an electrical power cable. Power circuitry 137 may also in certain embodiments be operable to deliver power from an external power source to power source 136. This may be, for example, for the charging of power source 136. Power circuitry 137 may perform any formatting, converting, or other modification to the power from power source 136 to make the power suitable for the respective components of WD 110 to which power is supplied.

Although the subject matter described herein may be implemented in any appropriate type of system using any suitable components, the embodiments disclosed herein are described in relation to a wireless network, such as the example wireless network illustrated in FIG. 8. For simplicity, the wireless network of FIG. 8 only depicts network 106, network nodes 160 and 160b, and WDs 110, 110b, and 110c. In practice, a wireless network may further include any additional elements suitable to support communication between wireless devices or between a wireless device and another communication device, such as a landline telephone, a service provider, or any other network node or end device. Of the illustrated components, network node 160 and wireless device (WD) 110 are depicted with additional detail. The wireless network may provide communication and other types of services to one or more wireless devices to facilitate the wireless devices' access to and/or use of the services provided by, or via, the wireless network.

The communication system 106 may itself be connected to a host computer (not shown), which may be embodied in the hardware and/or software of a standalone server, a cloud-implemented server, a distributed server or as processing resources in a server farm. The host computer may be under the ownership or control of a service provider or may be operated by the service provider or on behalf of the service provider.

The communication system of FIG. 8 as a whole enables connectivity between one of the connected WDs 110 and the host computer. The connectivity may be described as an over-the-top (OTT) connection. The host computer and the connected WDs 110 are configured to communicate data and/or signaling via the OTT connection, using an access network, a core network, any intermediate network and possible further infrastructure (not shown) as intermediaries. The OTT connection may be transparent in the sense that at least some of the participating communication devices through which the OTT connection passes are unaware of routing of uplink and downlink communications.

The host computer may provide host applications which may be operable to provide a service to a remote user, such as a WD 110 connecting via an OTT connection terminating at the WD 110 and the host computer. In providing the service to the remote user, the host application may provide user data which is transmitted using the OTT connection. The “user data” may be data and information described herein as implementing the described functionality. In one embodiment, the host computer may be configured for providing control and functionality to a service provider and may be operated by the service provider or on behalf of the service provider. The host computer may be enabled to observe, monitor, control, transmit to and/or receive from the network node 160 and or the wireless device 110.

One or more of the various embodiments in this disclosure improve the performance of OTT services provided to the WD 110 using the OTT connection. More precisely, the teachings of some of these embodiments may improve the data rate, latency, and/or power consumption and thereby provide benefits such as reduced user waiting time, relaxed restriction on file size, better responsiveness, extended battery lifetime, etc.

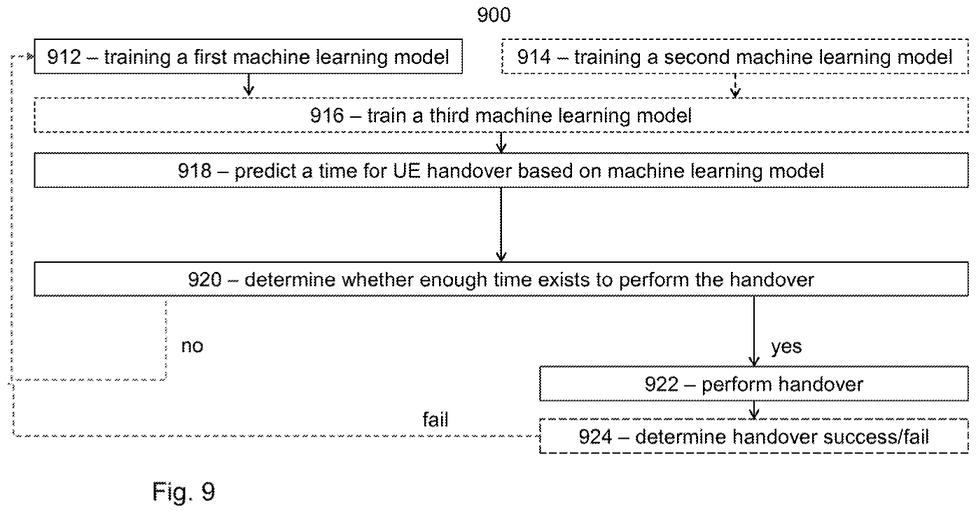

FIG. 9 is a flowchart illustrating an example method 900 in a network node, according to certain embodiments. In particular embodiments, one or more steps of FIG. 9 may be performed by network node 160 described with respect to FIG. 8.

The method begins at step 912 where a network node (e.g., network node 160) trains a first machine learning model. For example, the network node may train the first machine learning model according to any of the training method described with respect to FIGS. 1-7. For example, training may be based on radio link monitoring measurements for a UE from a plurality of geographic positions within a first cluster of cells, times of handover of the UE to target cells of the first cluster of cells, and cell identifiers of the target cells of the first cluster of cells for each handover.

In some embodiments, the machine learning model comprises a recurrent neural network or long short-term memory network. Training may be based on network simulation.

The method may include step 914, where the network node trains a second machine learning model. For example, similar to step 912, the network node may train the second machine learning model according to any of the training method described with respect to FIGS. 1-7. The second machine learning model may be different than the first machine learning model.

The method may include step 916, where the network node trains a third machine learning model based on the outputs of one or more of the first and second machine learning models. For example, the network node may train the third machine learning model according to any of the training method described with respect to FIGS. 5-7.

At step 918, the network node predicts a time for UE handover to a target cell using the one or more of the machine learning models, radio link monitoring measurements for the UE, and geographic positions associated with the radio link monitoring measurements.

For example, in some embodiments the network node may use the first machine learning model from step 912, along with current inputs from the UE, such as RLM and GPS, to predict a handover. In some embodiments, the network node may use both the first and second machine learning model from steps 912 and 914, respectively, along with current inputs from the UE, such as RLM and GPS, to predict a handover. In some embodiments, depending on the degree of similarity of the outputs from each prediction model, the network node may adjust the predictions to determine a final prediction. In some embodiments, the network node may select the output of the first or second machine learning model based on a category type of the UE. For example, the first machine learning model may be better suited (i.e., provide more accurate predictions) for a first category type and the second machine learning model may be better suited for a second category type. Although a first and second machine learning model are described, particular embodiments may use any suitable number of machine learning models.

In some embodiments, the predictions determined from the first and second machine learning models are input into a third machine learning model, as in step 916, and the network node may use the third machine learning model along with current inputs from the UE, such as RLM and GPS, to predict a handover.

At step 920, the network node determines whether enough time exists to perform the UE handover before the predicted handover time. If not enough time exists, the method returns to step 912 and starts over. In some embodiments, before returning to step 912, the network node may use an alternative method as described with respect to FIG. 4. At step 912, the network node may use the information about the predicted handover time to update the machine learning model. Similarly, for embodiments with more than one machine learning model (e.g., steps 914 and 916), the network node may also update those machine learning models.

If enough time exists to perform the UE handover, then the method continues to step 922 where the network node performs the UE handover to the target cell.

At step 924, the network node may determine whether the UE handover was successful. If the handover failed, the method continues to step 912 where the network node updates the machine learning model based on the failure information. Similarly, for embodiments with more than one machine learning model (e.g., steps 914 and 916), the network node may also update those machine learning models.

Modifications, additions, or omissions may be made to method 900 of FIG. 9. Additionally, one or more steps in the method of FIG. 9 may be performed in parallel or in any suitable order. The network node may comprise a base station, such as an eNB or gNB, a core network node, a cloud computing node, or any other suitable network component.

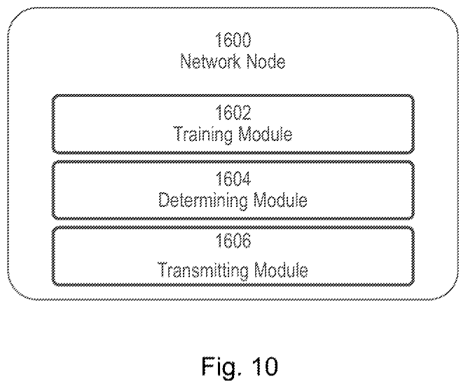

FIG. 10 illustrates an example network node, according to certain embodiments. The network node 1600 comprises network node 160 illustrated in FIG. 8.

Network node 1600 is operable to carry out the example method described with reference to FIG. 9 and possibly any other processes or methods disclosed herein. It is also to be understood that the method of FIG. 9 is not necessarily carried out solely by apparatus 1600. At least some operations of the method can be performed by one or more other entities, including virtual apparatuses.

Network node 1600 may comprise processing circuitry such as 170 of FIG. 8. In some implementations, the processing circuitry may be used to cause training module 1602, determining module 1604, transmitting module 1606, and any other suitable units of network node 1600 to perform corresponding functions according one or more embodiments of the present disclosure.

As illustrated in FIG. 10, network node 1600 includes training module 1602, determining module 1604, and transmitting module 1606. In certain embodiments, training module 1602 may train one or more machine learning models according to any of the embodiments and examples described above. Determining module 1604 may determine whether to perform a handover based on the output of the one or more machine learning models and whether a handover succeeded according to any of the embodiments and examples described herein. Transmitting nodule 1606 transmits handover requests according to any of the embodiments and examples described herein.

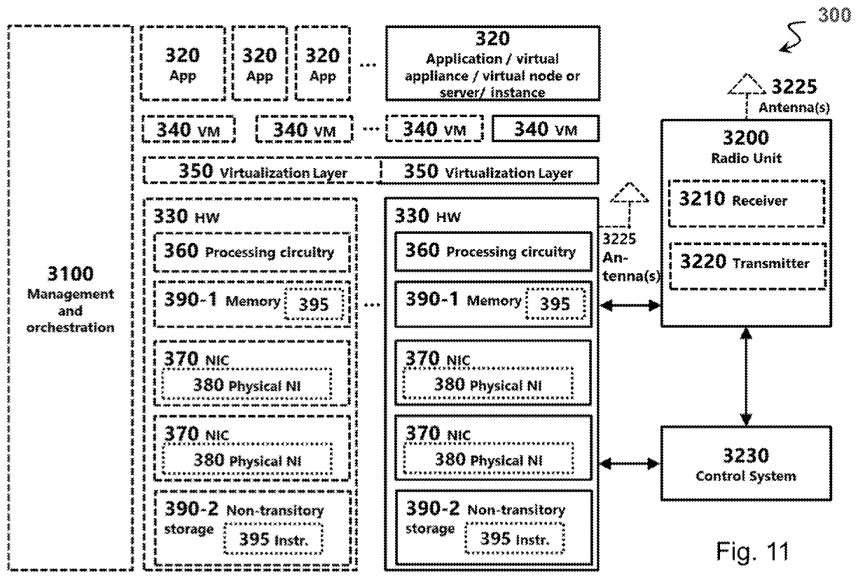

FIG. 11 is a schematic block diagram illustrating a virtualization environment 300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein, such as the method of FIG. 9, may be implemented as virtual components executed by one or more virtual machines implemented in one or more virtual environments 300 hosted by one or more of hardware nodes 330. Further, in embodiments in which the virtual node is not a radio access node or does not require radio connectivity (e.g., a core network node), then the network node may be entirely virtualized.

The functions may be implemented by one or more applications 320 (which may alternatively be called software instances, virtual appliances, network functions, virtual nodes, virtual network functions, etc.) operative to implement some of the features, functions, and/or benefits of some of the embodiments disclosed herein. Applications 320 are run in virtualization environment 300 which provides hardware 330 comprising processing circuitry 360 and memory 390. Memory 390 contains instructions 395 executable by processing circuitry 360 whereby application 320 is operative to provide one or more of the features, benefits, and/or functions disclosed herein.

Virtualization environment 300, comprises general-purpose or special-purpose network hardware devices 330 comprising a set of one or more processors or processing circuitry 360, which may be commercial off-the-shelf (COTS) processors, dedicated Application Specific Integrated Circuits (ASICs), or any other type of processing circuitry including digital or analog hardware components or special purpose processors. Each hardware device may comprise memory 390-1 which may be non-persistent memory for temporarily storing instructions 395 or software executed by processing circuitry 360. Each hardware device may comprise one or more network interface controllers (NICs) 370, also known as network interface cards, which include physical network interface 380. Each hardware device may also include non-transitory, persistent, machine-readable storage media 390-2 having stored therein software 395 and/or instructions executable by processing circuitry 360. Software 395 may include any type of software including software for instantiating one or more virtualization layers 350 (also referred to as hypervisors), software to execute virtual machines 340 as well as software allowing it to execute functions, features and/or benefits described in relation with some embodiments described herein.

Virtual machines 340, comprise virtual processing, virtual memory, virtual networking or interface and virtual storage, and may be run by a corresponding virtualization layer 350 or hypervisor. Different embodiments of the instance of virtual appliance 320 may be implemented on one or more of virtual machines 340, and the implementations may be made in different ways.

During operation, processing circuitry 360 executes software 395 to instantiate the hypervisor or virtualization layer 350, which may sometimes be referred to as a virtual machine monitor (VMM). Virtualization layer 350 may present a virtual operating platform that appears like networking hardware to virtual machine 340.

As shown in FIG. 11, hardware 330 may be a standalone network node with generic or specific components. Hardware 330 may comprise antenna 3225 and may implement some functions via virtualization. Alternatively, hardware 330 may be part of a larger cluster of hardware (e.g. such as in a data center or customer premise equipment (CPE)) where many hardware nodes work together and are managed via management and orchestration (MANO) 3100, which, among others, oversees lifecycle management of applications 320.

Virtualization of the hardware is in some contexts referred to as network function virtualization (NFV). NFV may be used to consolidate many network equipment types onto industry standard high-volume server hardware, physical switches, and physical storage, which can be located in data centers, and customer premise equipment.

In the context of NFV, virtual machine 340 may be a software implementation of a physical machine that runs programs as if they were executing on a physical, non-virtualized machine. Each of virtual machines 340, and that part of hardware 330 that executes that virtual machine, be it hardware dedicated to that virtual machine and/or hardware shared by that virtual machine with others of the virtual machines 340, forms a separate virtual network elements (VNE).

Still in the context of NFV, Virtual Network Function (VNF) is responsible for handling specific network functions that run in one or more virtual machines 340 on top of hardware networking infrastructure 330 and corresponds to application 320 in FIG. 11.

In some embodiments, one or more radio units 3200 that each include one or more transmitters 3220 and one or more receivers 3210 may be coupled to one or more antennas 3225. Radio units 3200 may communicate directly with hardware nodes 330 via one or more appropriate network interfaces and may be used in combination with the virtual components to provide a virtual node with radio capabilities, such as a radio access node or a base station.

In some embodiments, some signaling can be effected with the use of control system 3230 which may alternatively be used for communication between the hardware nodes 330 and radio units 3200.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa.

The foregoing description sets forth numerous specific details. It is understood, however, that embodiments may be practiced without these specific details. In other instances, well-known circuits, structures and techniques have not been shown in detail in order not to obscure the understanding of this description. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments, whether or not explicitly described.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the scope of this disclosure, as defined by the claims below.

1. A method for use in a network node for predicting handover, the method comprising:
training a first sequential time-based machine learning model using:
radio link monitoring measurements for a user equipment from a plurality of geographic positions within a first cluster of cells;
times of handover of the UE to target cells of the first cluster of cells; and
cell identifiers of the target cells of the first cluster of cells for each handover;
training a second sequential time-based machine learning model using:
radio link monitoring measurements for a user equipment from a plurality of geographic positions within a second cluster of cells;
times of handover of the UE to target cells of the second cluster of cells; and
cell identifiers of the target cells of the second cluster of cells for each handover;
predicting a time for a UE handover to a target cell using the first sequential time-based machine learning model, the second sequential time-based machine learning model, radio link monitoring measurements for the UE, and geographic positions associated with the radio link monitoring measurements;
determining whether enough time exists to perform the UE handover before the predicted handover time; and
upon determining enough time exists to perform the UE handover before the predicted handover time, performing the UE handover to the target cell.

2. The method of claim 1, further comprising upon determining not enough time exists to perform the UE handover before the predicted handover time, updating the first sequential time-based machine learning model based on an estimated time to perform the UE handover.

3. The method of claim 1, further comprising:
determining the UE handover to the target cell failed; and
updating the first sequential time-based machine learning model based on the failure information.

4. (canceled)

5. The method of claim 1, wherein the first sequential time-based machine learning model is a different model than the second sequential time-based machine learning model.

6. The method of claim 5, wherein predicting the time for a UE handover to a target cell uses the first or second sequential time-based machine learning model based on a category type of the UE.

7. The method of claim 1, further comprising training a third sequential time-based machine learning model using outputs of the first and second sequential time-based machine learning models; and
wherein predicting the time for a UE handover to a target cell comprises using the third sequential time-based machine learning model, radio link monitoring measurements for the UE, and geographic positions associated with the radio link monitoring measurements.

8. The method of claim 1, wherein the first sequential time-based machine learning model comprises a recurrent neural network or long short-term memory network.

9. The method of claim 1, wherein training the first sequential time-based machine learning model is based on network simulation.

10. The method of claim 1, wherein the network node is a base station.

11. The method of claim 1, wherein the network node is a core network node.

12. A network node operable to predict handover, the network node comprising processing circuitry configured to:
train a first sequential time-based machine learning model using:
radio link monitoring measurements for a user equipment from a plurality of geographic positions within a first cluster of cells;
times of handover of the UE to target cells of the first cluster of cells; and
cell identifiers of the target cells of the first cluster of cells for each handover;
train a second sequential time-based machine learning model using:
radio link monitoring measurements for a user equipment from a plurality of geographic positions within a second cluster of cells;
times of handover of the UE to target cells of the second cluster of cells; and
cell identifiers of the target cells of the second cluster of cells for each handover;
predict a time for a UE handover to a target cell using the first sequential time-based machine learning model, the second sequential time-based machine learning model, radio link monitoring measurements for the UE, and geographic positions associated with the radio link monitoring measurements;
determine whether enough time exists to perform the UE handover before the predicted handover time; and
upon determining enough time exists to perform the UE handover before the predicted handover time, perform the UE handover to the target cell.

13. The network node of claim 12, the processing circuitry further configured to, upon determining not enough time exists to perform the UE handover before the predicted handover time, update the first sequential time-based machine learning model based on an estimated time to perform the UE handover.

14. The network node of claim 12, the processing circuitry further configured to:
determine the UE handover to the target cell failed; and
update the first sequential time-based machine learning model based on the failure information.

15. (canceled)

16. The network node of claim 12, wherein the first sequential time-based machine learning model is a different model than the second sequential time-based machine learning model.

17. The network node of claim 16, wherein the processing circuitry is configured to predict the time for a UE handover to a target cell by using the first or second sequential time-based machine learning model based on a category type of the UE.

18. The network node of claim 12, the processing circuitry further configured to train a third sequential time-based machine learning model using outputs of the first and second sequential time-based machine learning models; and
wherein the processing circuitry is configured to predict the time for a UE handover to a target cell by using the third sequential time-based machine learning model, radio link monitoring measurements for the UE, and geographic positions associated with the radio link monitoring measurements.

19. The network node of claim 12, wherein the first sequential time-based machine learning model comprises a recurrent neural network or long short-term memory network.

20. The network node of claim 12, wherein the processing circuitry is operable configured to train the first sequential time-based machine learning model based on network simulation.

21. The network node of claim 12, wherein the network node is a base station.

22. The network node of claim 12, wherein the network node is a core network node.

23. (canceled)
